(19) United States
(12) Patent Application Publication
(10) Pub. No.: US 2006/0153310 A1
(43) Pub. Date: Jul. 13, 2006

(54) Time-domain equalizer for discrete multi-tone based DSL systems with cyclic extension in training

(75) Inventor: Tai-Lai Tung, Irvine, CA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Conexant Systems, Inc., Red Bank, NJ (US)

(21) Appl. No.: 11/320,918

(22) Filed: Dec. 30, 2005

Related U.S. Application Data
(60) Provisional application No. 60/641,736, filed on Jan. 7, 2005.

(51) Int. Cl. H04K 1/10

(52) U.S. Cl. 375/260

(57) ABSTRACT

The present invention provides for a method and system to implement time-domain equalizer (TEQ) training to shorten the channel impulse response of twisted copper lines for DMT-based VDSL systems. The coefficients of TEQ are trained when training signal has cyclic extension (CE), such as specified in current VDSL standard and proposed for VDSL2. The invention effects frame alignment and removal of CE to effectively permit implementation of TEQ training for VDSL where the training signal has cyclic extension. The advantage of this new invent is that Intersymbol interference (ISI) can be reduced in the current VDSL systems and FFT (Fast Fourier Transform) can be applied in place of presently used DFT (Direct Fourier Transform) for TEQ training. Use of the present invention in effectively implementing TEQ training in systems having cyclic extension results in reduced complexity, power saving, reduced memory requirements in terms of code space, and cost savings

### CROSS REFERENCE TO RELATED APPLICATION

This application claims priority to provisional application No. 60/641,736 filed Jan. 7, 2005 entitled “Time-Domain Equalizer for Discrete Multi-tone based DSL Systems with Cyclic Extension in Training”, hereby incorporated by reference in its entirety.

### FIELD OF THE INVENTION

The present invention relates to multi-carrier communication systems and more particularly to systems and methods for training a time domain equalizer (TEQ) in discrete multi-tone (DMT) VDSL systems with cyclic extension in training signals.

### BACKGROUND OF THE INVENTION

Discrete Multi-tone (DMT) is a common multi-carrier modulation scheme that has been implemented in many Digital Subscriber Lines (DSL). As used herein “xDSL” is understood to denote any type of DSL service (e.g., ADSL, DMT-based VDSL, VDSL2, etc.).

DMT transmission is a multi-carrier transmission technique in which a large number of sinusoids are modulated by complex-valued quadrature amplitude modulation (QAM) symbols and transmitted in parallel. Performing an inverse FFT (IFFT) on the complex valued constellation points generates samples of the continuous-time signal to be transmitted during a DMT symbol period. At the receiver, the QAM symbols are recovered by performing an FFT on the analog-to-digital-converted received signal [1].

Consider transmission over an ideal channel, that is, all frequency components of the DMT signal are equally attenuated. By choosing the carrier frequencies to be a multiple of the DMT symbol rate, the signals transmitted over the different carriers are independent and perfectly separated by the FFT at the receiver. Hence, DMT consists of a large number of modulated carriers that are orthogonal. Obviously, independent transmission channels are obtained only if appropriate symbol synchronization is performed at the receiver to compensate for the delay introduced by the channel [2].

Unfortunately, the telephony loop introduces severe frequency-dependent attenuation of the signal. In frequency-division multiplexed (FDM) DMT, filters are required to separate upstream from downstream transmission. Hence, the impulse response length of the composite equivalent discrete channel depends not only on the cable characteristics, but also on the impulse responses of the transceiver filters and service splitter—plain old telephone service (POTS) or integrated services digital network (ISDN)—included in the end-to-end signal path. The nonzero impulse response length results in inter-DMT symbol interference. This can be avoided by inserting a cyclic prefix (a copy of the last samples of the DMT symbol) between DMT symbols. The length of the prefix (samples) must be longer than the memory of the channel. In doing so, orthogonality between the carriers of the same symbol is also restored. The transient at the beginning of each DMT symbol (introduced by transmission over the channel) is absorbed in the prefix, which is removed at the receiver. The outputs of the demodulating FFT then equal the transmitted QAM symbols multiplied by the channel transfer function taken at the carrier frequencies. Hence, channel equalization is easily performed by multiplying each FFT output with a single complex coefficient equal to the inverse of the channel transfer function at the corresponding frequency.

In a DMT-based xDSL system, Time Domain Equalization (TEQ) is typically used to reduce the delay spread of the twisted copper line channel such that the equalized channel impulse response can be accommodated by the length of the cyclic prefix. When the delay spread of equalized channel is smaller than the length of the cyclic prefix, not only can the inter-symbol interference (ISI) be reduced in the time domain, but also the inter-channel interference (ICI) can be reduced in the frequency domain since the orthogonality between sub-bands is preserved.

To combat inter-symbol interference (ISI) introduced by a dispersive transmission channel, equalization is required. In discrete multi-tone (DMT) modulation, an elegant equalization method relies on inserting a guard time between transmitted symbols. Equalization of the channel is then achieved by multiplying each of the fast Fourier transform (FFT) outputs at the receiver with a single complex coefficient. This technique works well, provided that the time span of the cyclic extension, inserted for the duration of the guard time, is longer than the channel impulse response. This tutorial gives an overview of the different equalization techniques that can be used when the channel impulse response is longer than the cyclic extension. Time domain and frequency domain equalization techniques are presented.

A major advantage of the equalization method based on cyclic prefix insertion and single-tap frequency domain correction is its low computational complexity. The price to be paid is a reduction of the data rate caused by insertion of the cyclic prefix. For severe ISI channels that have long impulse responses, the efficiency loss associated with the prefix insertion becomes unacceptable. Hence, equalization techniques are called for that can handle the situation where the cyclic prefix is (significantly) shorter than the channel impulse response.

In previous work, TEQ training is performed either purely in the time-domain or purely in the frequency-domain. This may be disadvantageous because of associated increases in memory usage, computational work and complexity. Other drawbacks of existing systems also exist. For example, the techniques disclosed in “Equalizer Training Algorithms for Multi-carrier Modulation Systems”, J. S. Chow, J. M. Cioffi, and J. A. C. Bingham, which is hereby incorporated by reference.

In addition, there are new TEQ training techniques such as that described in U.S. patent application Ser. No. 10/008,364, filed Apr. 8, 2003, entitled “Reduced Complexity Time Frequency Trained Equalizer For Discrete Multi-tone-Based DSL Systems”, which is incorporated by reference herein. The '364 application provides, among other things, a system and method for implementing a new TEQ training approach that trains TEQ coefficients by exploiting both time-domain and frequency-domain information. An advantage of this technique is that it reduces memory usage due to the training process. In addition, the complexity of the training process is simplified, and the associated computational work is reduced. The reduction of memory usage and computational work in turn may lead to cost savings, power consumption savings and other advantages. This technique may be used in any xDSL system and provides a method for determining equalizer coefficients for channel equalization in DMT based xDSL systems. For example, the method may first comprise determining an impulse response value in a time domain. The method may further comprise applying windowing to the impulse response value to determine a windowed impulse response value. In addition, the method may comprise determining a residual error signal based upon the windowed impulse response value and adjusting an equalizer coefficient by an amount that is based upon the residual error signal. In some embodiments the method may further comprise first transforming the residual error signal to a frequency domain to generate a transformed residual error signal, modifying the transformed residual error signal by an estimated channel response value to form an interim value, transforming the interim value to a time domain to generate a correction factor and adjusting the equalizer coefficient by an amount proportional to the correction factor. Transformation may be accomplished by Fast Fourier Transform (FFT) or Inverse Fast Fourier Transform (IFFT) as is appropriate

Although TEQ training techniques such as those described above may be applied in VDSL and VDSL2 type systems, it is typically not applied because it would add too much complexity and require too much of computational resources. Further, in systems having cyclic extension, such as VDSL and VDSL2, there is a concern that removing the cyclic extension would adversely affect orthogonality in the frequency domain and cause greater inter-carrier interference.

### SUMMARY OF THE INVENTION

In view of the foregoing limitations of existing systems and methods, various embodiments of the present invention provide, among other things, a new approach to train the time-domain equalizer (TEQ), which shortens the channel impulse response of twisted copper lines for DMT-based VDSL systems. The coefficients of TEQ are trained when training signal has cyclic extension (CE), such as specified in current VDSL standard and proposed for VDSL2. The invention effects frame alignment and removal of CE to effectively permit implementation of TEQ training for VDSL where the training signal has cyclic extension. The advantage of this new invent is that Inter-symbol interference (ISI) can be reduced in the current VDSL systems and FFT (Fast Fourier Transform) can be applied in place of presently used DFT (Direct Fourier Transform) for TEQ training. Use of the present invention in effectively implementing TEQ training in systems having cyclic extension results in reduced complexity, power saving, reduced memory requirements in terms of code space, and cost savings.

Therefore, at least one embodiment of the invention may provide a method of TEQ training for VDSL-based systems that use training signals having cyclic extension. The method according to this embodiment may comprise receiving an VDSL signal at a transceiver from a VDSL channel, performing frame alignment, removing cyclic extension from each VDSL frame, averaging the received signal, and performing TEQ training.

Another embodiment according to this invention may provide a system for performing TEQ training in a DMT-based VDSL transceiver. The system for performing TEQ training in a DMT-based VDSL transceiver according to this embodiment may provide an input adapted to receive an analog information signal, an A/D converter, circuitry adapted to perform frame alignment, circuitry adapted to remove a cyclic extension from aligned frames prior to TEQ processing, and circuitry adapted to perform TEQ training based on frames devoid of cyclic extension.

Yet another embodiment of the invention may provide a VDSL chipset. The VDSL chipset according to this embodiment may comprise an analog front end, adapted to receive an analog VDSL signal, an A/D converter adapted to digitize the analog signal, a frame aligner, a cyclic extension stripper for striping a cyclic extension from a frame, a signal averaging circuit; and a TEQ training circuit.

These and other embodiments and advantages of the present invention will become apparent from the following detailed description, taken in conjunction with the accompanying drawings, illustrating by way of example the principles of the invention

### BRIEF DESCRIPTION OF THE DRAWINGS

FIG. 1 is a flow chart detailing the steps of a method for performing TEQ training in a conventional ADSL transceiver;

FIG. 2 is a flow chart detailing the steps of a method for performing TEQ training in accordance with at least one embodiment of the invention;

FIG. 3 is a graphic illustrating the reduction in frame bit size attributable to stripping cyclic extension according to at least one embodiment of the invention; and

FIGS. 4-6 are graphs illustrating the system performance of a transceiver employing a TEQ training techniques according to the various embodiments of the invention under test conditions.

### DETAILED DESCRIPTION

The following description is intended to convey a thorough understanding of the embodiments described by providing a number of specific embodiments and details involving systems and methods for performing targeted marketing with an electronic billboard based on detected attributes of objects associated with one or more audience members in proximity to the viewer. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

In DMT-based xDSL systems, TEQ may be used to reduce the delay spread of the twisted copper line channel such that the equalized channel impulse response can be accommodated by the length of the cyclic prefix. When the delay spread of equalized channel is smaller than the length of the cyclic prefix, not only the inter-symbol interference (ISI) can be reduced in the time domain, but also the inter-channel or inter-carrier interference (ICI) can be reduced in the frequency domain since the orthogonality between sub-bands is preserved.

In ADSL, TEQ is trained with a training signal without cyclic extension (CE). However, various embodiments of the present invention permit design and implementation of a new TEQ training approach for VDSL and other systems where the training signal has cyclic extension (CE). For purposes of this disclosure VDSL will refer to VDSL, VDSL2 and other systems, now known or hereafter developed, that have training with cyclic extension. To be clear, the invention may be implemented for any DMT-based xDSL where training signal has cyclic extension. Among other things, advantages of the various embodiments of the invention may include reduction in inter-symbol interference (ISI) in current VDSL systems, and enabling a FFT to be applied in place of a discrete Fourier transform (DFT) for TEQ training. This leads to complexity-reduction, power-saving, memory-saving in terms of code space, and cost-saving.

Various embodiments of this invention may be, for example, implemented in a DSP (digital signal processor) of a CPE (customer premises equipment) or a CO (central office). More particularly, the invention may be implemented in the frequency domain processor (FDP) element of the DSP core. For example, the invention may be implemented in the FDP of Conexant DSP named Mizard for customer premesis equipment (CPE) and in the Raptor DSP on the central office (CO) side, both of which are manufactured and distributed by CONEXANT SYSTEMS of Newport Beach, Calif.

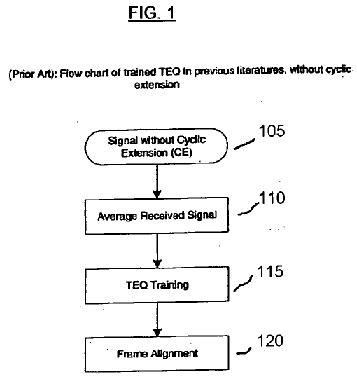

Referring now to FIG. 1, a flow chart detailing the steps of a prior art method for training a TEQ in an ADSL system is depicted. The process begins in step 105 where a signal (frame) is received that is does not employ cyclic extension, as for example, in conventional ADSL, as opposed to VDSL, VDSL2, etc. Next, in step 110, the averaged received signal is determined. Then, in step 115, TEQ training is performed. Finally, in step 120, after sufficient TEQ training has been performed, frame alignment is performed.

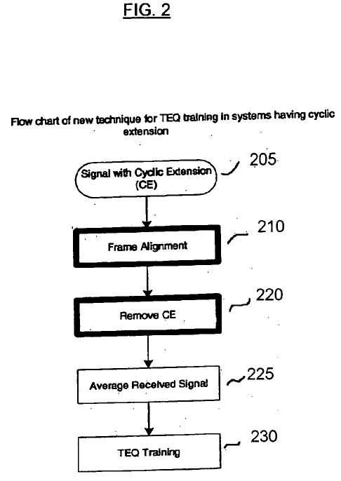

Referring now to FIG. 2, a flow chart detailing the steps of the TEQ training process according to at least one embodiment of the invention is depicted. The process begins in step 205 where a signal (frame) is received that includes cyclic extension. As discussed herein, in various embodiments, this may be a VDSL-based signal or a signal based on another protocol and/or standard that utilizes cyclic extension as a techniques to reduce inter-symbol interference (ISI). The process continues to step 210 where frame alignment is performed. Then, in step 215, cyclic extension is removed from each VDSL frame. As noted herein, the fact that this step is performed prior to TEQ training is a heretofore unknown techniques to which, the various improvements in performance and reductions in cost and complexity over known techniques afforded by the various embodiments of the invention may be attributed. Then, in step 220, the averaged received signal is determined so that, in step 225, TEQ training can be performed. In various embodiments, TEQ training may be performed in accordance with the teachings of commonly assigned, published U.S. Patent Application Nos. 2004/0202260, 20030112861 and/or 20030112860, all of which are hereby incorporated by reference in their entirety. In fact, any of these or any other known or previously undiscovered TEQ training routine may be performed with the various embodiments of the invention, so long as it is based on a protocol that utilizes cyclic extension.

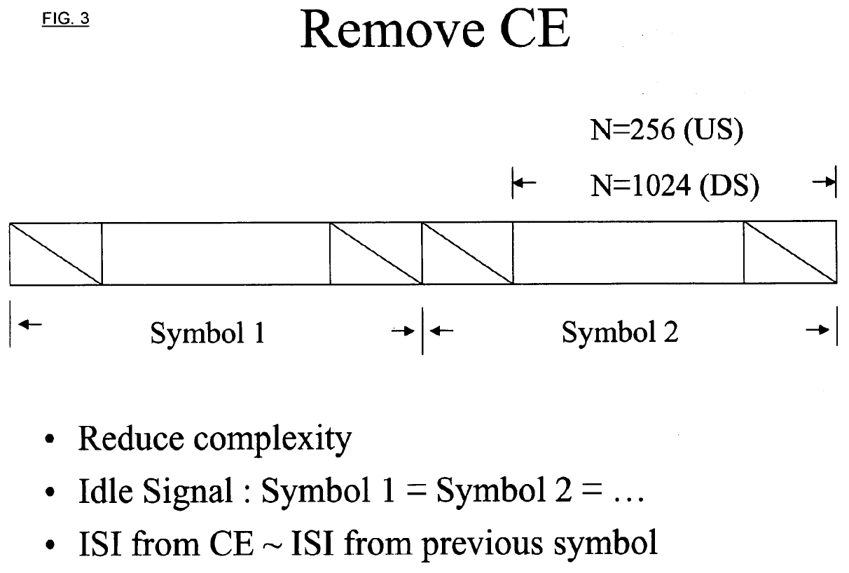

One advantage that may be achieved by the various embodiments of the invention is complexity reduction. As illustrated in FIG. 3, by removing the cyclic extension, the length of each frame is reduced to a power of 1024 (2¹⁰) bits. Therefore, after removing the cyclic extension, the length of each symbol, N, becomes 4096 (downstream). 4096 is 2¹². Therefore, the FFT/IFFT can be applied to replace DFT/IDFT in the TEQ training sequence leading to a reduction in hardware complexity, a savings in power consumption, memory-saving in terms of code space, and cost-saving in terms of manufacturing costs.

Another advantage that may be achieved by the various embodiments of the invention is that although data is being discarded, the circulant property (symbol N's suffix will be the same as Symbol (N+1)'s prefix) in the time domain and the orthogonality property between sub-channels in the frequency domain are both preserved. The various embodiments of the invention exploit the fact that the cyclic extension is an exact copy from the end portion of the preceding DMT frame. Thus, the inter-symbol interference (ISI) caused by the cyclic extension is the same as the inter-symbol interference (ISI) caused by the end portion of the previous DMT frame. Therefore, removing cyclic extension will not affect the circulant property in time domain, nor affect the orthogonality property in frequency domain.

An addition advantage that may be achieved by the various embodiments of the invention is a higher VDSL data rate. As is known in the art, using time domain equalization (TEQ) reduces the length of impulse response of the VDSL channel. Reducing the length of the impulse response reduces inter-symbol interference (ISI) in time domain, inter-channel interference (ICI) in frequency domain and increase signal-to-noise-ratio (SNR) of received VDSL signal, which, all lead to a higher VDSL transmission rate.

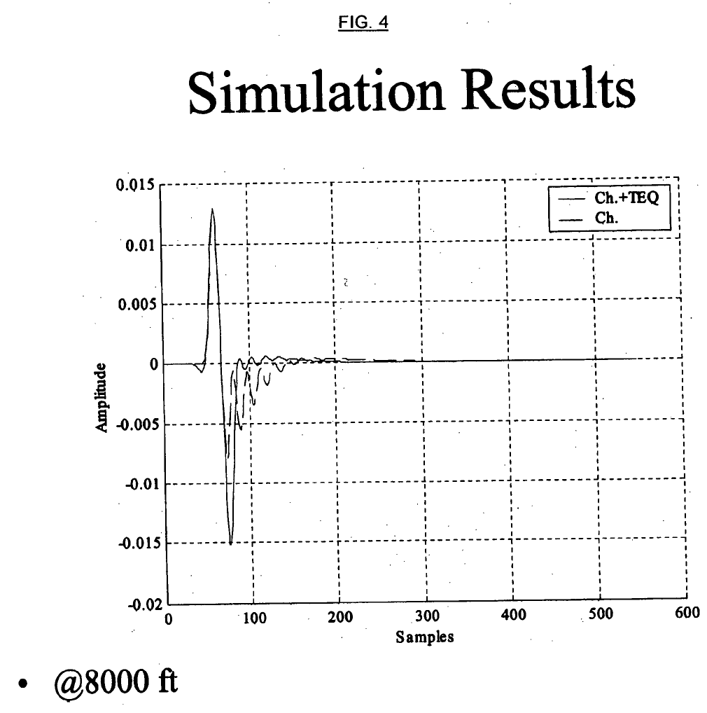

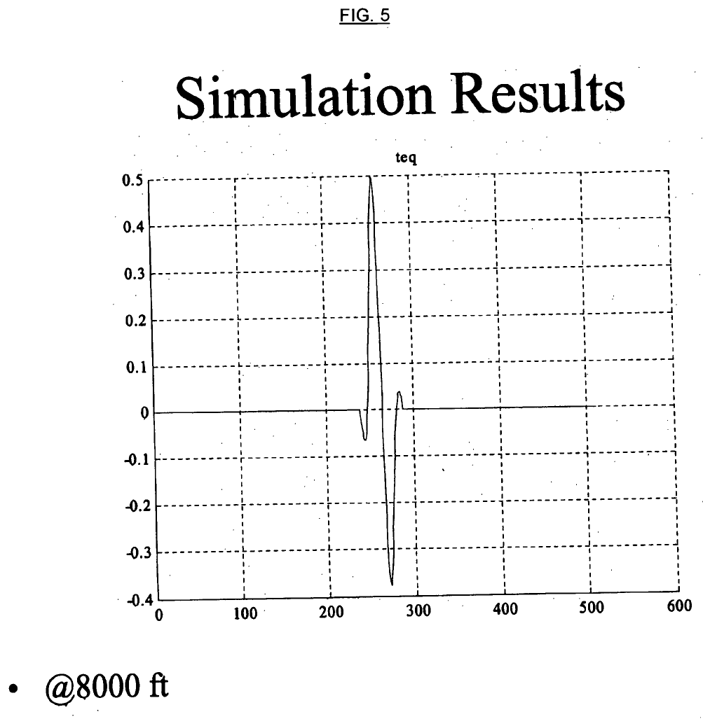

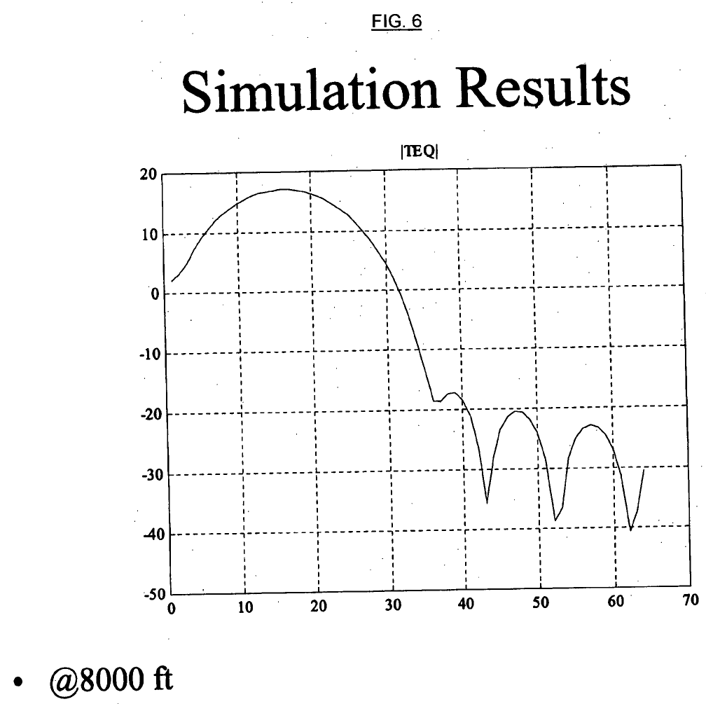

A simulation system was created to demonstrate the performance gain achieved using the VDSL TEQ training technique associated with the various embodiments of the invention. The simulation system simulated an environment of downstream VDSL from central office to customer premises with a loop length ranging from 4,000 to 14,000 feet. FIGS. 4-6 are graphs that illustrating the performance of the system at a loop length of 8000 feet. FIG. 4 illustrates the original channel impulse response (Ch) and the response after time domains equalization (TEQ) according to the various embodiments of the invention. As seen in FIG. 4, the original channel impulse response is dramatically reduced through TEQ. As noted herein, reducing the channel impulse response reduces inter-symbol interference (ISI) in time domain, inter-channel interference (ICI) in frequency domain and increase signal-to-noise-ratio (SNR) of received VDSL signal, which, all lead to a higher VDSL transmission rate FIG. 5 illustrates the TEQ coefficients after training and FIG. 6 shows the TEQ's frequency response covering the first 32 tones of upstream VDSL.

The embodiments of the present inventions are not to be limited in scope by the specific embodiments described herein. For example, although many of the embodiments disclosed herein have been described with reference to TEQ training in VDSL systems, the principles herein are equally applicable to aspects of DMT-based data transmission systems. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein. Many modifications to the embodiments described above can be made without departing from the spirit and scope of the invention.

1. A method of TEQ training for VDSL-based systems that use training signals having cyclic extension comprising:
receiving an VDSL signal at a transceiver from a VDSL channel;
performing frame alignment;
removing cyclic extension from each VDSL frame;
averaging the received signal; and
performing TEQ training.

2. The method according to claim 1, wherein an overall channel impulse response length is shorted.

3. The method according to claim 1, wherein removing cyclic extension makes a frame length of each frame a multiple of 1024 (2¹⁰) bits.

4. The method according to claim 3, wherein performing TEQ training comprises applying a fast Fourier transform (FFT) to train the TEQ.

5. The method according to claim 1, wherein neither the circulant property in the time domain nor the orthogonal property in the frequency domain are negatively affected by the step of removing cyclic extension.

6. A system for performing TEQ training in a DMT-based VDSL transceiver comprising:
an input adapted to receive an analog information signal;
an A/D converter;
circuitry adapted to perform frame alignment;
circuitry adapted to remove a cyclic extension from aligned frames prior to TEQ processing; and
circuitry adapted to perform TEQ training based on frames devoid of cyclic extension.

7. The system according to claim 6, wherein, the circuitry adapted to remove a cyclic extension from aligned frames prior to TEQ processing comprises circuitry adapted to shorten a length of each frame to a multiple of 1024 bits in length.

8. The system according to claim 7, wherein circuitry adapted to perform TEQ training based on frames devoid of cyclic extension comprises FFT circuitry adapted to perform an FFT operation.

9. The system according to claim 6, wherein the TEQ training without cyclic extension is characterized in that an overall channel impulse response length is shorted.

10. The system according to claim 6, wherein the system is adapted so that neither the circulant property in the time domain nor the orthogonal property in the frequency domain are negatively affected by the step of removing cyclic extension relative to TEQ training with cyclic extension.

11. A VDSL chipset comprising:
an analog front end, adapted to receive an analog VDSL signal;
an A/D converter adapted to digitize the analog signal;
a frame aligner;
a cyclic extension stripper for striping a cyclic extension from a frame;
a signal averaging circuit; and
a TEQ training circuit.

12. The chipset according to claim 11, wherein the cyclic extension stripper shortens a length of each frame to a multiple of 1024 bits in length for TEQ training.

13. The chipset according to claim 12, wherein the TEQ training circuit comprises a FFT circuit.

14. The chipset according to claim 11, wherein the TEQ training circuit shortens an overall VDSL channel impulse response length.

15. The chipset according to claim 11, wherein neither a circulant property in the time domain nor an orthogonal property in the frequency domain are negatively affected by the cyclic extenion stripper or the TEQ training circuit.
